(19) United States
(12) Patent Application Publication
(10) Pub. No.: US 2012/0296673 A1
(43) Pub. Date: Nov. 22, 2012

(54) MEDICAL RECORD CARD AND INTEGRATION OF HEALTH CARE

(75) Inventors: ROBERT SCOTT ACKERSON, Kansas City, MO (US); BRIAN ROBERT CARTER, Kansas City, MO (US); CLAY PATTERSON, Overland Park, KS (US)

(73) Assignee: CERNER INNOVATION, INC., Overland Park, KS (US)

(21) Appl. No.: 13/112,636

(22) Filed: May 20, 2011

(51) Int. Cl. G06Q 50/00

(52) U.S. Cl. 705/3

(57) ABSTRACT

Systems and methods for updating a user's health record and integrating medical care are provided. A user identification card is associated with the user's health record, and this user identification card may be employed by the user to authorize a user health record connection between an authenticated terminal and a user health record at a central data store. The user health record connection may be established at one or more of a plurality of authenticated terminals. The user health record connection may facilitate maintenance and updating of the user health record from the plurality of authenticated terminals. The user identification card provides seamless integration of the user's health record with a plurality of facilities having authenticated terminals, such as hospitals, clinics, pharmacies, fitness centers, grocery stores, schools, etc.

### CROSS-REFERENCE TO RELATED APPLICATIONS

This application is related to commonly assigned U.S. Patent Application entitled Medical Record Card and Integration of Health Care (Attorney Docket CRNI. 162540) filed concurrently herewith on the same date.

### FIELD

The present disclosure relates to health care record management.

### BACKGROUND

Maintenance of a patient health record may be encumbered by the limited interaction between clinics managing different aspects of a patient's health care. Information relevant to a patient's health record may be generated at multiple locations; however, this information is not necessarily included with the health record. Various health-related events are often not included in a health record due to poor maintainability. In addition, patients have a limited role in facilitating transfer of medical record information between various healthcare providers.

### SUMMARY

Examples are directed to methods, computer systems, and computer-storage media for use in updating a patient's health record that may be used in a variety of healthcare settings and applications. The health care record identification card may provide a patient with a portable and accurate method for maintaining his or her health care record. An authenticated terminal for use with the health care identification card may allow a clinic or other health provider to easily access and update a patient's health care record upon input of the identification information from the health care record identification card.

In one example, a method of updating a user's health record may be executed from computer-executable instructions stored on computer-storage media. The method of updating a user's health record may comprise receiving identification information from a user identification card at an authenticated terminal. The method may comprise determining whether a connection with a user health record for the user at a central data store is established for the authenticated terminal. If the connection is not established for the authenticated terminal, the method may comprise establishing the connection for the authenticated terminal with the user health record at the central data store.

Additionally, the method may comprise providing one or more additions to the user health record at the authenticated terminal, transmitting the one or more additions to the central data store, and storing the one or more additions at the central data store. The method may further comprise downloading a portion of the user health record to a database associated with the authenticated terminal. The method may comprise receiving a personal identification number from the user. In one example, the authenticated terminal may be associated with a hospital, a clinic, or a pharmacy. In another example, the authenticated terminal may be associated with a fitness center, grocery store, or restaurant.

In another example, a method for maintaining a user's health record may comprise associating a user identification card with a user health record and activating the user identification card with a user. The method for maintaining a user's health record may comprise receiving identifying information from the user identification card at a first authenticated terminal and determining whether the a user health record connection for the user has been established for the first authenticated terminal. The user health record connection connects to a user health record at a central data store. If the user health record connection has not been established for the first authenticated terminal, the method may comprise establishing the user health record connection for the first authenticated terminal.

In addition, the method may comprise providing one or more additions to the user health record at the first authenticated terminal, transmitting the one or more additions to the central data store, and storing the one or more additions at the central data store. The method may also comprise receiving approval from the user of the one or more additions prior to transmitting. The method may further comprise downloading at least a portion of the user health record to a database associated with the first authenticated terminal. Additionally, activating the user identification card with a user may occur at a second authenticated terminal. Activating the user identification card with a user may occur at a personal computing device. The first authenticated terminal may be associated with at least one of a hospital, a clinic, a pharmacy, a restaurant, a school, a fitness center, and a grocery store.

In an additional example, a system for maintaining a user health record is provided. The system may comprise a user identification card associated with a user health record and activated by the user, wherein the user health record is stored on a central data store. The system may comprise an authenticated terminal comprising at least one database and configured to receive information from the user identification card and further configured to determine if the authenticated terminal has a connection established with the user health record stored on the central data store. The system may comprise the central data store configured to store the user health record.

The authenticated terminal may also be configured to provide one or more additions to the user health record and transmit the one or more additions to the central data store. The central data store may be further configured to store the one or more additions in association with the user health record. Additionally, the authenticated terminal may be configured to receive approval from the user of the one or more additions to the user health record prior to transmission. The authenticated terminal may be associated with at least one of a hospital, a clinic, a pharmacy, a grocery store, a fitness center, or a restaurant. The authenticated terminal may be configured to receive a personal identification number from the user. The user identification card may comprise at least one of a magnetic strip and a bar code, and the authenticated terminal may comprise at least one of a magnetic strip reader and a bar code reader. The central data store may be further configured to transmit at least a portion of the user health record to the authenticated terminal and the authenticated terminal may be further configured to store the portion of the user health record to the at least one database.

This section provides a general summary of the disclosure, and is not a comprehensive disclosure of its full scope or all of its features. Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic of a system for maintaining a user health record.

FIGS. 2A-B are illustrations of a portion of a system for maintaining a user health record.

FIGS. 3A-B are illustrations of a portion of a system for maintaining a user health record.

FIG. 4 is a flowchart of a method for maintaining a user health record.

FIG. 5 is a flowchart of a method for maintaining a user health record.

FIG. 6 is a flowchart of a method for maintaining a user health record.

Corresponding reference numerals indicate corresponding parts throughout the several views of the drawings.

### DETAILED DESCRIPTION

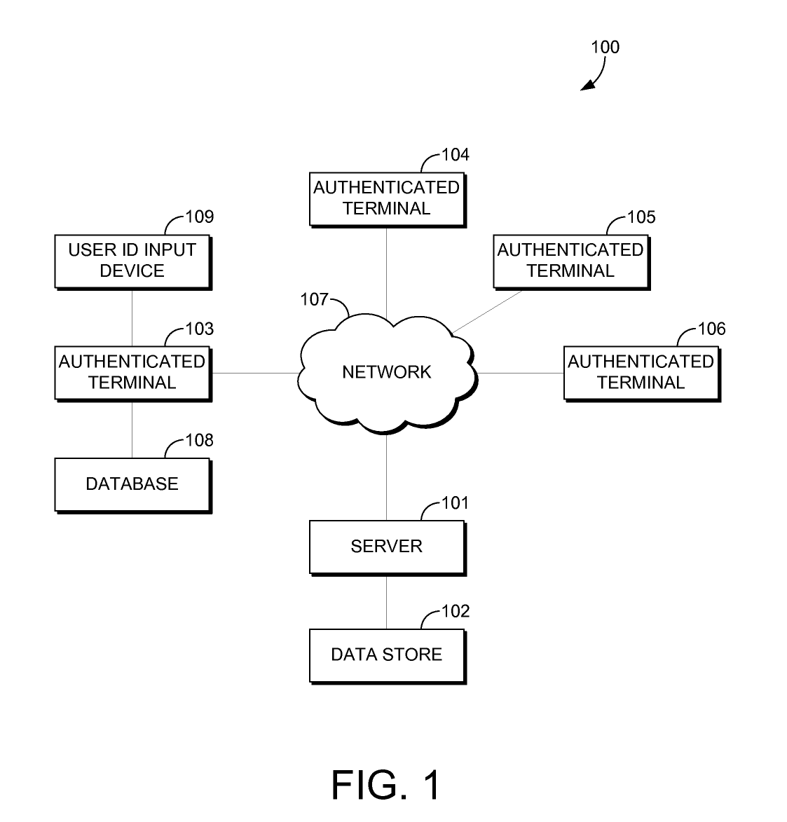

Referring to FIG. 1, one example of a system for maintaining a user health record is illustrated. Generally one or more servers 101 may be associated with a central data store 102, which may comprise a plurality of computer storage devices and capable of maintaining and storing user health records for a plurality of users. Exemplary server components may comprise a processing unit, internal system memory, and a suitable system bus for coupling various system components, including the central data store, with the server. The system bus may be any of several types of bus structures, including a memory bus or memory controller, a peripheral bus, and a local bus, using any of a variety of bus architectures.

The server 101 typically may include therein, or may have access to, a variety of computer-storage media, for instance, a data store 102. Computer-storage media may be any available media that may be accessed by the server 101 and may be removable or non-removable media. Computer storage media may comprise RAM, ROM, EEPROM, flash memory or other memory technology, CD-ROM, digital versatile disks (DVDs) or other optical disk storage, magnetic cassettes, magnetic tape, magnetic disk storage, or other magnetic storage device, or any other medium which may be used to store the desired information and which may be accessed by the server 101. Combinations of any of the above also may be included within the scope of computer-storage media. Computer storage media provide storage of computer-executable instructions, data structures, and program modules, and other data for the server.

The server 101 may be linked to a plurality of authenticated terminals 103-106 via a network 107. The authenticated terminals 103-106 may be authenticated by an entity associated with the server. The authentication may be used to ensure that a terminal receiving user identification and health records is secure. The authentication may be used to verify other aspects of the facility employing the terminal. Authentication may be a one-time verification or it may be required each time the terminal connects with the server 101 via the network 107. Facilities that may choose to participate in the system for maintaining a user health record may include hospitals, clinics, pharmacies, fitness centers, restaurants, schools, and grocery stores. Each facility may have one or a plurality of authenticated terminals.

Authenticated terminals 103-106 may be located at a variety of locations in a medical or research environment, including clinical laboratories (e.g., molecular diagnostic laboratories), hospitals and other inpatient settings, veterinary environments, ambulatory settings, medical billing and financial offices, hospital administration settings, home healthcare environments, and providers' offices. Providers may comprise a treating physician or physicians; specialists such as surgeons, radiologists, cardiologists, and oncologists; emergency medical technicians; physicians' assistants; nurse practitioners; nurses; nurses' aides; pharmacists; dieticians; microbiologists; laboratory experts; laboratory technologists; genetic counselors; researchers; veterinarians; students; and the like. The authenticated terminals 103-106 may also be physically located in nontraditional medical care environments so that the entire healthcare community may be capable of integration on the network. The authenticated terminals 103-106 may be personal computers, servers, routers, network PCs, peer devices, other common network nodes, or the like and may comprise some or all of the elements described above in relation to the server 101. The devices may be personal digital assistants or other like devices.

Exemplary computer networks 107 comprise local area networks (LANs) and/or wide area networks (WANs). Such networking environments are commonplace in offices, enterprise-wide computer networks, intranets, and the Internet. When utilized in a WAN networking environment, the server 101 may comprise a modem or other means for establishing communications over the WAN, such as the Internet. In a networked environment, program modules or portions thereof may be stored in association with the server 101, the central data store 102, or any of the authenticated terminals 103-106. For example, various application programs may reside on the memory associated with any one or more of the authenticated terminal. It will be appreciated by those of ordinary skill in the art that the network connections shown are exemplary and other means of establishing a communications link between the computers (e.g., server 101 and authenticated terminals) may be utilized.

In operation, an organization may enter commands and information into the server 101 or convey the commands and information to the server 101 via one or more of the authenticated terminals through input devices, such as a keyboard, a pointing device (commonly referred to as a mouse), a trackball, or a touch pad. Other input devices comprise microphones, satellite dishes, scanners, or the like. In addition to a monitor, the control server 101 and/or authenticated terminals may comprise other peripheral output devices, such as speakers and a printer.

Although many other internal components of the server 101 and the authenticated terminal 103 are not shown, those of ordinary skill in the art will appreciate that such components and their interconnection are well known.

In one example of an authenticated terminal 103, the terminal may be associated with a database 108 that maintains information for the connection with a user health record stored at the central data store. The database 108 may also store local copy of user health record or a portion of the user health record. For example, a gym may not wish to have copy of the entire user health record and only save information from the patient's most recent physical assessment. The database 108 may be a component of the terminal 103; however, in another example, the database 108 may be remote from the terminal 103, such as a central storage system for the facility employing one or more authenticated terminals. The terminal may also be connected with a user identification input device 109. Generally, the user identification input device 109 may receive identification information from a user in order to initiate the request for establishing a user health record connection at the authenticated terminal 103. User identification information received at the authenticated terminal may be transmitted, whole or in part, to the central data store to determine which portions of the user health record are available for transmission to, display at, or addition to by the authenticated terminal. The user health care record connection between the authenticated terminal 103 and the user health record stored on the central data store may facilitate various functions such as transferring or updating the user's health record. The identification information may be stored on a card, in the form of a magnetic strip or a bar code. User identification information may be stored as a virtual user identification card on a user PDA, cellular phone, smart phone, tablet, or other portable computing device.

In one example, a user's health record may be linked to a health information card and, once activated by the user the health information card may be used by the user to quickly and seamlessly facilitate establishment of a connection to his or her health record at any facility using an authenticated terminal. A user joining a new fitness center, for example, may scan the information from his user identification card into an authenticated terminal at the fitness center. The terminal at the fitness center may determine if the user health record connection has already been established for the terminal and/or local database; if the user health record connection has not been established, the terminal may then establish the connection to the user health record at the central data store. The identification information from the user identification card may be transmitted, whole or in part, to the central data store to select a portion of the user health record. The authenticated terminal may receive the user health record or a portion of the user health record and store it at the database associated with the authenticated terminal. The authenticated terminal may also be configured to provide additions or updates the user health record and transmit the additions or updates to the central data store.

For example, after having been a member of the fitness center, the user above may have lost weight, gained muscle mass, and improved his blood pressure. The fitness center may input these changes into the authenticated terminal and further transmit these changes to the central data store so that the central data store maintains a current and accurate version of the user health record. The fitness center may provide additional information that may not be included in a conventional health record such as types of exercises performed, duration of exercise, and intensity level of the exercise.

This ability to coordinate changes in a health record may provide diagnostic or therapeutic benefits. For example, a user may have authorized connection with his health record at a fitness center, a grocery store, and a clinic. After going to the clinic for extreme fatigue, the clinician may view the updated health record reflecting the user's increased activity at the fitness center and also reflecting the high protein-low carbohydrate balance of the user's groceries. The clinician may utilize the information and also make recommendations for the user.

Moreover, the system for maintaining a user health record provides a patient with portability and continuity of care. A patient receiving several treatments for various disorders or diseases at multiple facilities may scan his user identification card at all of the facilities at which he is receiving care. Each of the facilities may employ an authenticated terminal, which, if the user health record connection was not previously established, established a connection with the user health record at the central data store. The facilities may employ an authenticated terminal, which, if the user health record was not previously stored, requests the user health record or relevant portions of the user health record from the central data store. The facilities may use the user identification information received from the card to select the relevant portions. A facility may embark on various treatment regimes for the patient and update the user health record and transmit these updates to the central data store. An authenticated terminal may be programmed to check for updates from the central data store periodically or before any change to the patient's prescribed treatment or each time the user identification information is input to the authenticated terminal.

Furthermore, if the patient moves to a new location, he may easily authorize a new set of facilities to establish a health record connection to access this information and maintain his treatments seamlessly. In one example, the patient or user may relocate to a different city but have access to a branch or franchise of his previous pharmacy or health care clinic. The authenticated terminal may have access to a database associated with all branches or franchises of the pharmacy. Thus, a separate authenticated terminal may be associated with a database that information for the connection to the user health record at the central data store. The patient may enter this pharmacy branch and his user identification information may be input into the authenticated terminal associated with this pharmacy branch, such as by scanning or swiping a user identification card. The authenticated terminal determines that the user health record connection has been previously established with another authenticated terminal sharing the database, for example in a database accessible to all authenticated terminals for this chain of pharmacies. The authenticated terminal is thus free to submit updates or additions to the user health care record. If the database maintains a local copy of the user health record, the authenticated terminal may also regard the input of the user identification information as a prompt to request updates and/or additions to the user health record stored on the database from the central data store. Any additions or updates available in the central data store are then transmitted and stored in the database associated with the authenticated terminal. The user's new pharmacy location has a connection to his most current health care record and, if desired, a local copy of the user health record may be updated from the central data store.

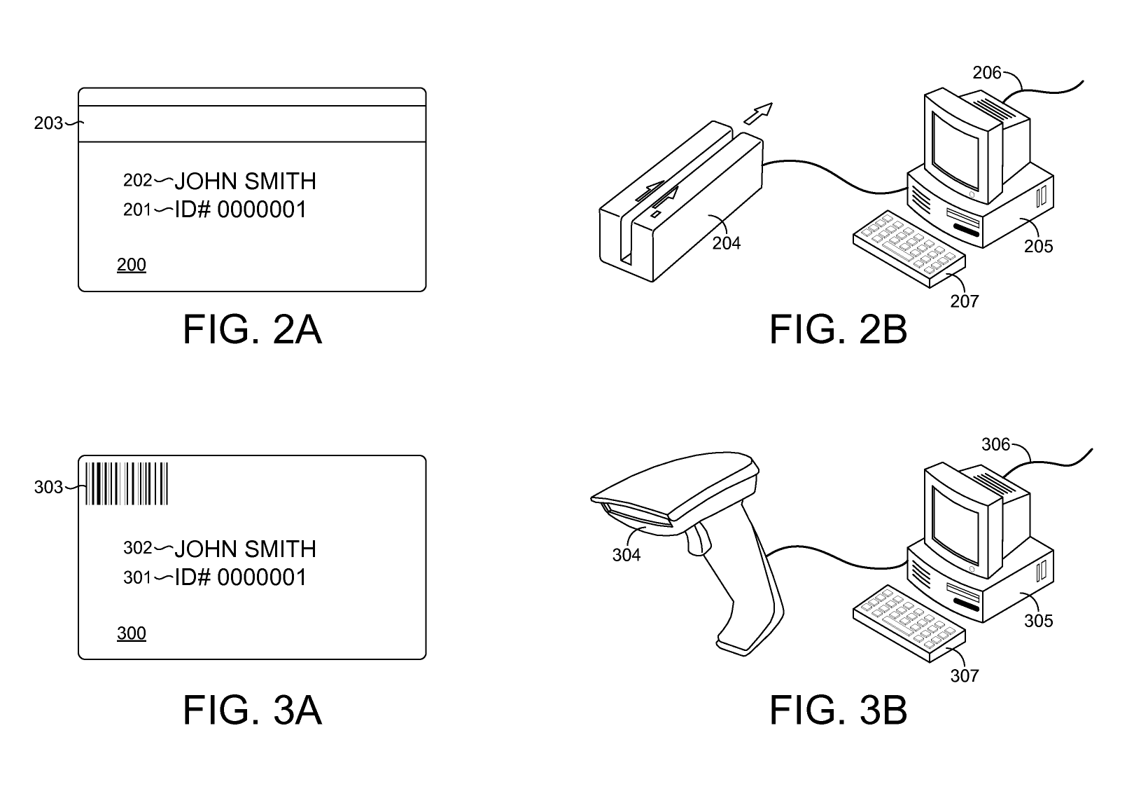

In FIGS. 2A-B and FIGS. 3A-B, examples of an authenticated terminal and user identification card of a system for maintaining user health records are illustrated. The exemplary operating environments are merely examples of suitable computing environments and are not intended to suggest any limitation as to the scope of use or functionality of the invention. Nor should the examples be interpreted as having any dependency or requirement relating to any single component or combination of components illustrated therein.

FIG. 2A illustrates one example of a user identification card 200 including a magnetic strip 203. The user identification card may also include various other items such as an identification number 201 and/or the user's name. A facility may wish to sponsor the user identification card 200, in which case a logo or other branding material may be included on the card. FIG. 2B illustrates an exemplary authenticated terminal 205 with a magnetic card reader 204. The authenticated terminal 205 may include a wired or wireless connection 206 to the network for interchange with the central data store. The authenticated terminal 205 may include a database or may be associated with a remote database. The authenticated terminal 205 may include a keyboard 207, touch screen, keypad, joystick, mouse, or other input device for updating or making additions to the user health record. The authenticated terminal 205 may also include another input for receiving user authorization of various transactions. For example, the user may wish to preview and approve additions to his or her health record prior to storage on the local database or transmittal to the central data store. In addition, the authenticated terminal 205 may be used to associate the user identification card with the user for activation. Additional security may be provided by requesting that the user to enter a personal identification number (PIN) along with swiping or otherwise inputting the information from his user identification card into the authenticated terminal.

FIGS. 3A-B presents another example of a user identification card and an authenticated terminal for receiving the information from the user identification card. In FIG. 3A, a user identification card 300 includes a barcode 303, which may be a one-dimensional or two-dimensional bar code with any form of encoding. The user identification card may also include various other items such as an identification number 301 and/or the user's name 302. A facility may wish to sponsor the user identification card 300, in which case a logo or other branding material may be included on the card. FIG. 3B illustrates an exemplary authenticated terminal 205 with a magnetic card reader 304. The authenticated terminal 305 may include a wired or wireless connection 306 to the network for interchange with the central data store. The authenticated terminal 305 may include a database or may be associated with a remote database. The authenticated terminal 305 may include a keyboard 307, touch screen, keypad, joystick, mouse, or other input device for updating or making additions to the user health record. The authenticated terminal 305 may also include another input for receiving user authorization of various transactions.

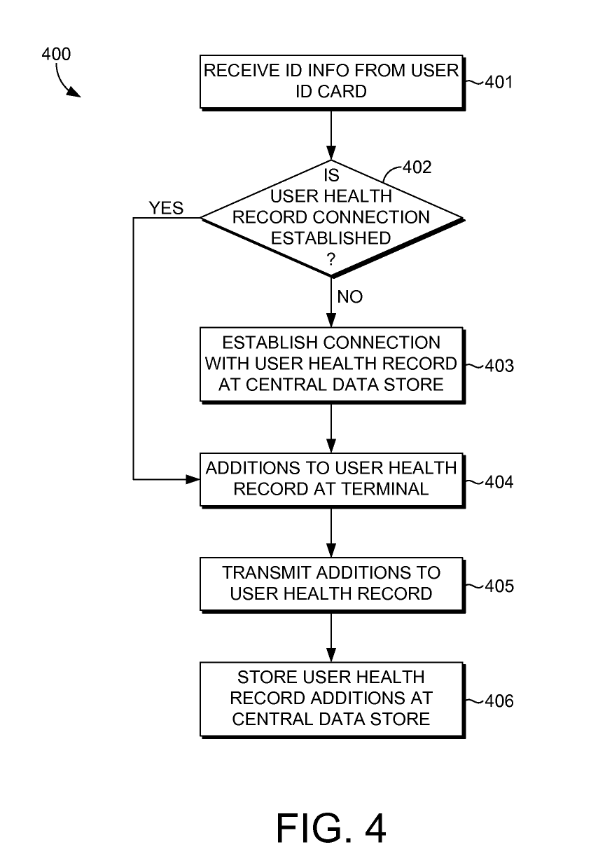

Referring to FIG. 4, a flowchart illustrates a method of updating a user's health record 400. At step 401, identification information may be received from a user ID card at an authenticated terminal. The identification information may be provided on a physical card or may be in virtual form. At step 402, the authenticated terminal may determine whether a user health record connection for the user has been established the authenticated terminal. If the user health record connection has not been established, the authenticated terminal may establish this connection with the user health record at a central data store given the identification information at step 403. Once the user health record connection has been established, the user health record may be maintained. For example, the user health record may be amended by providing one or more additions at the authenticated terminal at step 404.

At step 405, the authenticated terminal may transmit additions to the user health record to the central data store. Additions may include new tests performed, new treatments prescribed, updated physiological and/or mental parameters, or any other deviations from the previously stored user health record. Next, in step 406, the additions to the user health record may be stored at the central data store. In addition, the authenticated terminal may request a portion of the user health record from the central data store using a part of the user identification information and store the information on a database associated with the central. The authenticated terminal may also request updates to the stored local version from the central data store.

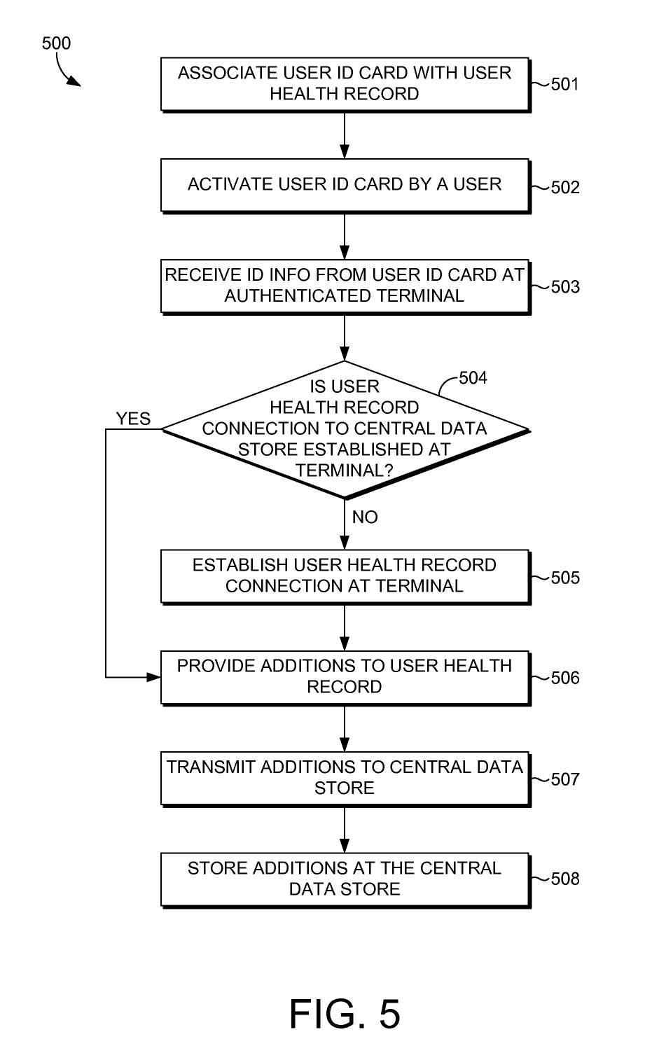

In FIG. 5, an example of a method 500 for updating a user's health record is provided. In step 501, a user identification card may be associated with a user health record. The user identification card may be activated by a user at step 502. This activation may occur at the authenticated terminal or the activation may occur at a personal computing device, over the phone, at a separate authenticated terminal, etc. At this point, the user identification card is activated and may provide the user linked to the card with seamless portability and updatability to his health care record. The user may wish to have his health care record available to an authenticated terminal, such as one located at a hospital, clinic, pharmacy, fitness center, school, grocery store, or restaurant. The user may seek to establish a connection with his health care record at the various locations so that the various locations may provide updates to the health care record at the central data store or may also allow the locations to store a local copy of a portion of his health record. The first authenticated terminal receives identifying information from the user identification card at step 503. The first authenticated terminal determines if the user health record connection has been established for the first authenticated terminal at step 504. If the user health record was not previously stored, the first authenticated terminal, given the identification information provided by the user, may establish the user health record connection with the user health record at a central data store at step 505.

Once the connection with the user health record has been established for the authenticated terminal, additions and updates to the user health record may be performed. In step 506, one or more additions to the user health record may be performed at the first authenticated terminal. The user may be provided with the opportunity to preview and approve the additions to his or her user health record and approval may be received at the authenticated terminal. The user may approve the additions locally at the authenticated terminal or the user may be notified by email, instant messaging, phone call or the like of the one or more additions and be provided with the opportunity to approve at that point. Next, at step 507, the authenticated terminal may transmit the one or more additions to the central data store. At step 508, the central data store may store the one or more additions. In addition, the central data store may keep a record of all of the authenticated terminals possessing a local copy of relevant portions of the user's health record and transmit updates to all of the authenticated terminals.

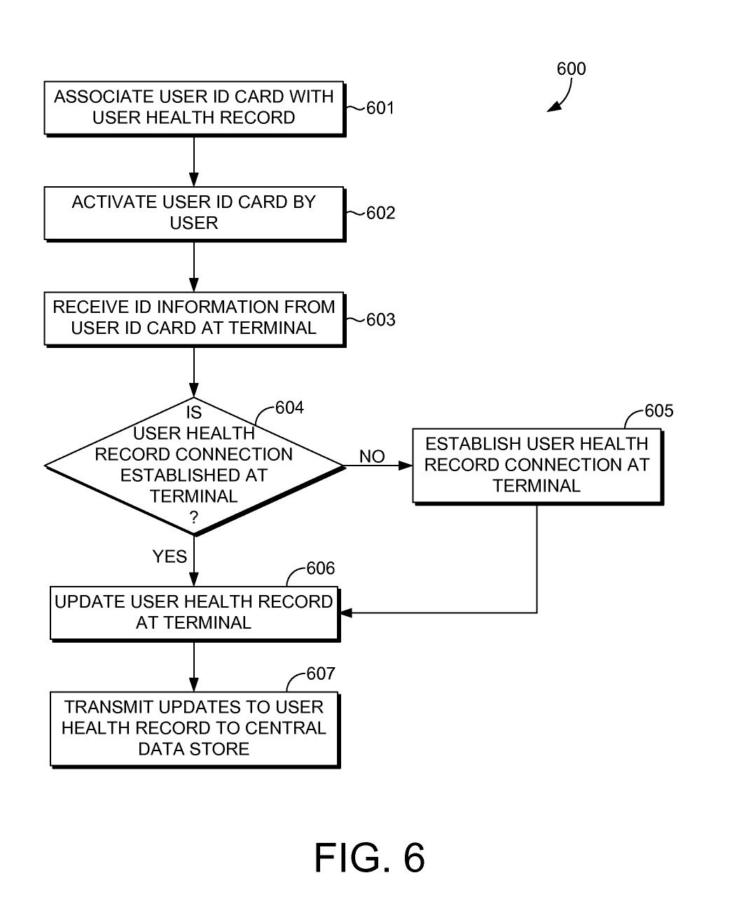

Referring to FIG. 6, an additional example of a method 600 for updating a user's health record is provided. In step 601, a user identification card may be associated with a user health record. The user identification card may be activated by a user at step 602. This activation may occur at the authenticated terminal or the activation may occur at a personal computing device, over the phone, at a separate authenticated terminal, etc. Once active, the user identification card may provide the user with seamless portability and maintenance of his health care record. The user may input his identification information via the user identification card to a first authenticated terminal to have his health care record available to an authenticated terminal, such as one located at a hospital, clinic, pharmacy, fitness center, school, grocery store, or restaurant. The first authenticated terminal receives identifying information from the user identification card at step 603. The first authenticated terminal determines if the user health record connection has been established with the user health record stored at the central data store at step 604. If the user health record connection was not previously established, the first authenticated terminal may establish the user health record connection with the central data store at step 605 and may also store a portion of the user health record at the database associated with the first authenticated terminal.

If it is determined that the user health record connection has been established, in step 606, the first authenticated terminal may provide one or more updates to the user health record. Next at step 607, the one or more updates to the user health record may be transmitted to the central data store. This may provide the user, as well as the facility managing the authenticated terminal, with more accurate health records. In addition, if the authenticated terminal has a local copy of a portion of the user health record, the authenticated terminal may make additions to the user health record stored on the database associated with the health record as described above or request updates from the central data store.

For example, a user joining a fitness center may have an activated user identification card and a complete user health record stored at a central data store. The fitness center may have an authenticated terminal for receiving information from the user identification card. Upon enrolling at the fitness center, the user inputs information from his user identification card into the authenticated terminal, such as by swiping or scanning portions of the card. The authenticated terminal determines if there a connection to the user health record at the central data store has been established; if not, the authenticated terminal establishes the connection to the user health record. The user and/or fitness center may keep a record of his fitness progress, various aches and pains experienced during exercise, goals, and so forth, which may be input to the authenticated terminal for transmitting to the central data store and included with the user health record. In addition, it may be useful for the fitness center to store a portion of the health record, such as a physician's approval to engage in strenuous activity that may be part of the health record. The authenticated terminal may request and download the physician's approval information within the health record from the central data store. The portion of the health record may also be transmitted via fax, mail, email, etc. The portions of the health record that may be selected for transmission may be determined by the identification information and may be selected or extracted by the central data store. Permissions for transmittal of the portion of the health record may be maintained as a part of the complete health record at the central data store or permissions may be obtained from the user.

In another example, a user having the user identification card may be visiting a new urgent care facility. The urgent care facility may not have medical history information for the user. The urgent care facility has an authenticated terminal, in which the user inputs identification information from his user identification card. The authenticated terminal determines if there a connection to the user health record at the central data store has been established; if not, the authenticated terminal establishes the connection to the user health record. Via the connection and/or using the identification information, a clinician at the authenticated terminal may view the user health record stored at the central data store. For example, the clinician may search the user health record for blood type, current medications, and allergies for the user. The urgent care facility may have access to the most critical information for the immediate treatment of the user. Additionally, rather than view the remote record at the central data store, a portion of the complete health record may be designated for transmittal to urgent care facilities, in which case, that portion of the health care record is transmitted to the urgent care facility authenticated terminal and stored on the local database. Furthermore, treatments administered by the urgent care facility may be submitted to the central data store to make additions to or update the user health record via the user health record connection.

In another example, a user having the user identification card may be visiting his primary care physician. The primary care physician may have access to an authenticated terminal in which the user inputs identification information from his user identification card. The authenticated terminal determines if there a connection to the user health record at the central data store has been established; if not, the authenticated terminal establishes the connection to the user health record. Via the connection and/or using the identification information, the physician at the authenticated terminal may view the user health record stored at the central data store. The physician looking for the most recent updates to the user health record may see that the user has joined a new fitness center and his health related activities at the fitness center. The physician may see in the user health record that the user sought treatment at an urgent care center and what new medications were administered. The primary care physician may want to keep a local copy of the user's medical history, but not his fitness activity. In which case, the physician may request a download of this portion of the user health record to a local database associated with the authenticated terminal. In another example, the physician may simply print out a copy of the relevant portions of the user health records. The physician may wish to keep a complete health record, in which case, he may request to download the entire health record to the local database associated with the authenticated terminal. The portions of the health record that may be selected for transmission may be determined by the identification information and may be selected or extracted by the central data store. Permissions for transmittal of the portion of the health record may be maintained as a part of the complete health record at the central data store or permissions may be obtained from the user.

The system and methods described may be operational with numerous other general purpose or special purpose computing system environments or configurations. Examples of well-known computing systems, environments, and/or configurations that may be suitable for use with the present invention include personal computers, server computers, hand-held or laptop devices, multiprocessor systems, microprocessor-based systems, set top boxes, programmable consumer electronics, network PCs, minicomputers, mainframe computers, distributed computing environments that include any of the above-mentioned systems or devices, and the like.

The systems and methods may be described in the general context of computer-executable instructions, such as program modules, being executed by a computer. Exemplary program modules comprise routines, programs, objects, components, and data structures that perform particular tasks or implement particular abstract data types. The present invention may be practiced in distributed computing environments where tasks are performed by remove processing devices that are linked through a communications network. In a distributed computing environment, program modules may be located in association with local and/or remove computer storage media (e.g. memory storage devices).

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and may be used in a selected embodiment, even if not specifically shown or described.

What is claimed is:

1. Computer-storage media having computer-executable instructions stored thereon that, when executed, perform a method of updating a user's health record, the method comprising:
receiving identification information from a user identification card at an authenticated terminal;
determining whether a connection with a user health record for the user at a central data store is established for the authenticated terminal; and
if the connection is not established for the authenticated terminal, establishing the connection for the authenticated terminal with the user health record at the central data store.

2. The method of claim 1, the method further comprising:
providing one or more additions to the user health record at the authenticated terminal;
transmitting the one or more additions to the central data store; and
storing the one or more additions to the user health record at the central data store.

3. The method of claim 1, wherein the authenticated terminal is associated with at least one of a hospital, clinic, or pharmacy.

4. The method of claim 1, the method further comprising: receiving a personal identification number from the user.

5. The method of claim 1, wherein the authenticated terminal is associated with at least one of a fitness center, grocery store, or restaurant.

6. The method of claim 1, the method further comprising downloading a portion of the user health record to a database associated with the authenticated terminal.

7. A method for maintaining a user's health record, the method comprising:
associating a user identification card with a user health record;
activating the user identification card with a user;
receiving identifying information from the user identification card at a first authenticated terminal;
determining whether a user health record connection for the user has been established for the first authenticated terminal, wherein the user health record connection connects to a user health record at a central data store; and
if the user health record connection has not been established for the first authenticated terminal,
establishing the user health record connection for the first authenticated terminal.

8. The method of claim 7, the method further comprising:
providing one or more additions to the user health record at the first authenticated terminal;
transmitting the one or more additions to the central data store; and
storing the one or more additions at the central data store.

9. The method of claim 7, the method further comprising:
downloading at least a portion of the user health record to a database associated with the first authenticated terminal.

10. The method of claim 7, wherein activating the user identification card with a user occurs at a second authenticated terminal.

11. The method of claim 7, wherein activating the user identification card by the user occurs at a personal computing device.

12. The method of claim 7, wherein the first authenticated terminal is associated with at least one of a hospital, a clinic, a pharmacy, a restaurant, a school, fitness center, and a grocery store.

13. The method of claim 8, the method further comprising:
receiving approval from the user of the one or more additions prior to transmitting.

14. A system for maintaining a user health record, the system comprising:
a user identification card associated with a user health record and activated by the user, wherein the user health record is stored on a central data store;
an authenticated terminal comprising at least one database and configured to receive information from the user identification card and to determine if the authenticated terminal has a connection established with the user health record stored on the central data store; and
the central data store configured to store the user health record.

15. The system of claim 14, the authenticated terminal further configured to provide one or more additions to the user health record and transmit the one or more additions to the central data store and the central data store further configured to store the one or more additions in association with the user health record.

16. The system of claim 15, the authenticated terminal further configured to receive approval from the user of the one or more additions to the user health record prior to transmission.

17. The system of claim 14, wherein the authenticated terminal is associated with at least one of a hospital, a clinic, a pharmacy, a grocery store, a fitness center, or a restaurant.

18. The system of claim 14, the authenticated terminal further configured to receive a personal identification number from the user.

19. The system of claim 14, the user identification card comprising at least one of a magnetic strip and a bar code and the authenticated terminal comprising at least one of a magnetic strip reader and bar code reader.

20. The system of claim 14, the central data store further configured to transmit at least a portion of the user health record to the authenticated terminal and the authenticated terminal further configured to store the portion of the user health record to the at least one database.
